(19) United States
(12) Patent Application Publication
(10) Pub. No.: US 2013/0111901 A1
(43) Pub. Date: May 9, 2013

(54) PULSATION ABSORPTION SYSTEM FOR AN ENGINE

(71) Applicants: Thomas G. Leone, Ypsilanti, MI (US); Ross Dykstra Pursifull, Dearborn, MI (US); James Leiby, Dryden, MI (US)

(72) Inventors: Thomas G. Leone, Ypsilanti, MI (US); Ross Dykstra Pursifull, Dearborn, MI (US); James Leiby, Dryden, MI (US)

(73) Assignee: FORD GLOBAL TECHNOLOGIES, LLC, Dearborn, MI (US)

(21) Appl. No.: 13/290,728

(22) Filed: Nov. 7, 2011

(51) Int. Cl. F02B 33/44

(52) U.S. Cl. 60/611

(57) ABSTRACT

A pulsation absorption system for a turbocharged engine is provided herein. The pulsation absorption system includes a pulsation absorption device coupled to an air passage at a position between a compressor and a turbine, wherein the pulsation absorption device is configured to selectively increase a volume of the air passage. In this way, it is possible to reduce surge while limiting increase in turbo lag.

### BACKGROUND AND SUMMARY

Vehicles may include a turbocharged internal combustion engine. During low speed and high load engine operating conditions, turbocharged engines can experience compressor surge. Surge is an unstable operating region of the compressor at low mass flow and high pressure ratio (e.g., high boost). Surge can be attributed to pulsations in the intake airflow, and also by fluctuations in turbo speed caused by pulsations in the exhaust airflow. Some turbocharged engines are controlled such that the turgocharger does not operate during low speed and high load; however, this limits engine operation and affects vehicle launch performance. Other turbocharged engines may include a resonating device for dampening pressure fluctuations.

For example, US2008/0184705 describes a chamber for dampening pulsations generated at a compressor output. The dampening chamber is connected directly to the compressor output and includes annular spaces that extend outwards from an intake passage to increase the volume of the intake passage. Further, the dampening chamber includes annular slots that allow airflow to passively enter/exit the annular spaces.

The inventors herein have recognized various issues with the above system. In particular, increasing the volume of the intake system may increase turbo lag. For example, increased volume during high engine speed may adversely affect the time needed for the turbine to change speed and function effectively in response to a throttle change. An operator may notice a hesitation in throttle response at tip in, for example.

As such, one example approach to address the above issues is to selectively communicate a pulsation absorption system with an engine intake system and/or an engine exhaust system. In this way, it is possible to achieve high boost at both low engine speed and high engine speed, while reducing flow pulsations and thus, reducing the tendency for compressor surge. Specifically, the pulsation absorption system may include a pulsation absorption device that selectively and/or temporarily increases a volume of the intake and/or exhaust systems such that turbocharger surge is reduced. In some embodiments, the pulsation absorption system may include a resonator, a diaphragm, a bladder, and/or another pulsation absorption device. Further, by taking advantage of selectively and/or temporarily increasing the volume of the intake and/or exhaust systems, a surge line associated with the turbocharged engine may be changed. In other words, the pulsation absorption system dynamically adjusts a volume of an engine air passage in response to an engine operating condition to absorb a pressure and/or flow pulsation, when desired.

Note that various bypass passages, and valves may be included in a pulsation absorber system. Further, a controller may control the pulsation absorber such that the pulsation absorber selectively communicates with the engine intake system and/or the engine exhaust system. Further still, various sensors may provide feedback to the control system regarding an operating state of the engine, if desired.

It should be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE DRAWINGS

FIG. 1 shows a schematic diagram of an example engine including a turbocharger.

FIG. 2 shows an example pulsation absorption system that may be included in the example engine of FIG. 1 according to an embodiment of the present disclosure.

FIG. 3 shows another example pulsation absorption system that may be included in the example engine of FIG. 1 according to an embodiment of the present disclosure.

FIG. 4 shows another example pulsation absorption system that may be included in the example engine of FIG. 1 according to an embodiment of the present disclosure.

FIG. 5 shows another example pulsation absorption system that may be included in the example engine of FIG. 1 according to an embodiment of the present disclosure.

FIG. 6 shows a flowchart for a controller of the example engine of FIG. 1 for controlling a pulsation absorption system according to an embodiment of the present disclosure.

### DETAILED DESCRIPTION

The following description relates to a turbocharged engine that includes a pulsation absorption system, which is arranged in such a way that turbocharger surge is reduced. The pulsation absorption system may include a pulsation absorption device which may be coupled to an engine intake system and/or an engine exhaust system to selectively and/or temporarily increase a volume of the intake and/or exhaust systems. This arrangement allows flow pulsations to be absorbed such that the turbocharged engine can achieve high boost at both low engine speed and high engine speed. This system allows the advantage for more design freedom while improving launch performance at peak power. Various valves may be included in the disclosed system. For example, the pulsation absorption system may include one or more of a reed valve, a butterfly valve, a flapper valve, a poppet valve, a slide valve, a ball valve, a plug valve, a sleeve valve, etc. Further, the pulsation absorption system may include one or more bypass passages, which may include one or more of the aforementioned valves. In this way, the pulsation absorption system dynamically adjusts a volume of an engine air passage in response to an engine operating condition to absorb a pressure and/or flow pulsation, when desired.

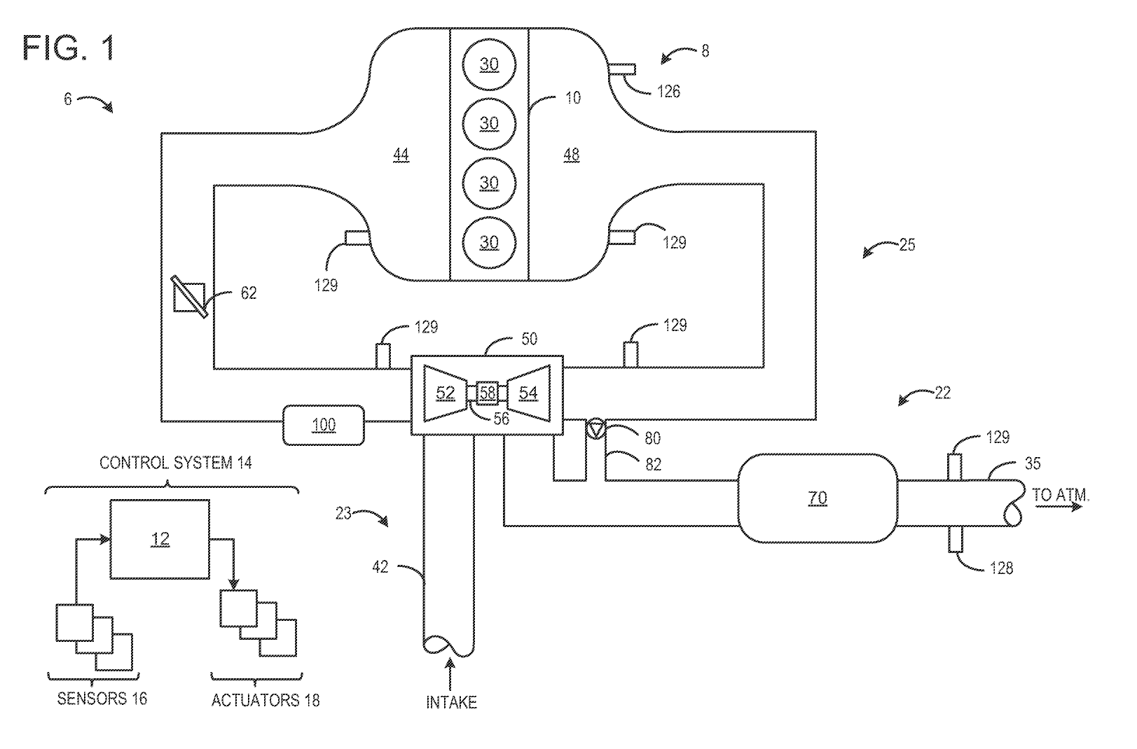

FIG. 1 shows a schematic depiction of a vehicle system 6. The vehicle system 6 includes an engine system 8 coupled to an exhaust after-treatment system 22. The engine system 8 may include an engine 10 having a plurality of cylinders 30. Engine 10 includes an engine intake system 23 and an engine exhaust system 25. Engine intake system 23 includes a throttle 62 fluidly coupled to the engine intake manifold 44 via an intake passage 42. The engine exhaust system 25 includes an exhaust manifold 48 eventually leading to an exhaust passage 35 that routes exhaust gas to the atmosphere. Throttle 62 may be located in intake passage 42 downstream of a boosting device, such as turbocharger 50, or a supercharger. Turbocharger 50 may include a compressor 52, arranged between intake passage 42 and intake manifold 44. Compressor 52 may be at least partially powered by exhaust turbine 54, arranged between exhaust manifold 48 and exhaust passage 35. Compressor 52 may be coupled to exhaust turbine 54 via shaft 56.

Compressor 52 may also be at least partially powered by an electric motor 58. In the depicted example, electric motor 58 is shown coupled to shaft 56. However, other suitable configurations of the electric motor may also be possible. In one example, the electric motor 58 may be operated with stored electrical energy from a system battery (not shown) when the battery state of charge is above a charge threshold. By using electric motor 58 to operate turbocharger 50, for example at engine start, an electric boost (e-boost) may be provided to the intake aircharge. In this way, the electric motor may provide a motor-assist to operate the boosting device. As such, once the engine has run for a sufficient amount of time (for example, a threshold time), the exhaust gas generated in the exhaust manifold may start to drive exhaust turbine 54. Consequently, the motor-assist of the electric motor may be decreased. That is, during turbocharger operation, the motor-assist provided by the electric motor 52 may be adjusted responsive to the operation of the exhaust turbine. Further, engine exhaust system 25 may include a wastegate valve 80 and a corresponding bypass passage 82 to divert exhaust gases away from turbine 54. As such, the wastegate valve 80 may regulate boost levels, and thus may affect the operating speed of turbine 54 and compressor 52. However, pressure fluctuations may also affect turbocharger performance.

A pulsation absorption system 100 may be coupled to engine intake system 23 downstream from compressor 52, as shown. Additionally or alternatively, the pulsation absorption system may be coupled to engine exhaust system 25 upstream from turbine 54. As described in more detail below, the pulsation absorption system may include a pulsation adsorption device such as a resonator, a diaphragm, and/or a bladder. Further, the pulsation absorption system may include one or more valves and/or a bypass passage for selectively communicating the pulsation adsorption device with the engine intake system and/or the engine exhaust system.

Engine exhaust system 25 may be coupled to exhaust after-treatment system 22 along exhaust passage 35. Exhaust after-treatment system 22 may include one or more emission control devices 70, which may be mounted in a close-coupled position in the exhaust passage 35. One or more emission control devices may include a three-way catalyst, lean NOx filter, SCR catalyst, etc. The catalysts may enable toxic combustion by-products generated in the exhaust, such as NOx species, unburned hydrocarbons, carbon monoxide, etc., to be catalytically converted to less-toxic products before expulsion to the atmosphere. However, the catalytic efficiency of the catalyst may be largely affected temperature by the temperature of the exhaust gas. For example, the reduction of NOx species may require higher temperatures than the oxidation of carbon monoxide. Unwanted side reactions may also occur at lower temperatures, such as the production of ammonia and N₂O species, which may adversely affect the efficiency of exhaust treatment, and degrade the quality of exhaust emissions. Thus, catalytic treatment of exhaust may be delayed until the catalyst(s) have attained a light-off temperature. Exhaust after-treatment system 22 may also include hydrocarbon retaining devices, particulate matter retaining devices, and other suitable exhaust after-treatment devices (not shown).

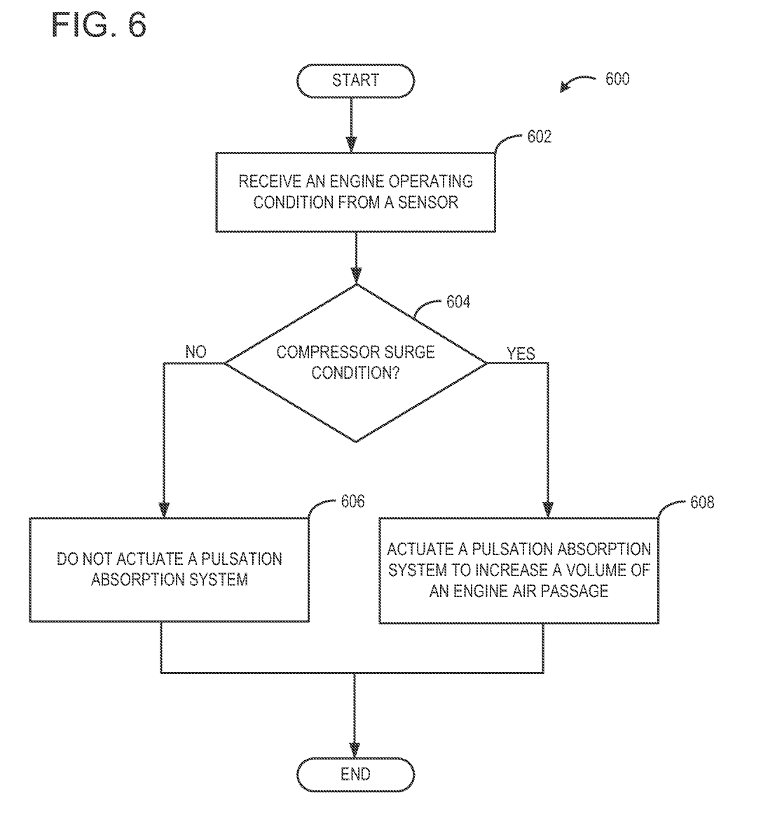

The vehicle system 6 may further include control system 14. Control system 14 is shown receiving information from a plurality of sensors 16 (various examples of which are described herein) and sending control signals to a plurality of actuators 18 (various examples of which are described herein). As one example, sensors 16 may include exhaust gas sensor 126 (located in exhaust manifold 48), temperature sensor 128, and various pressure sensors 129. For example, a pressure sensor 129 may be located downstream of emission control device 70, downstream from compressor 52, upstream from turbine 54, within intake manifold and/or within exhaust manifold 48. Other sensors such as pressure, temperature, air/fuel ratio, and composition sensors may be coupled to various locations in the vehicle system 6. As another example, the actuators may include fuel injectors (not shown), a variety of valves, pump 58, and throttle 62. The control system 14 may include a controller 12. The controller may receive input data from the various sensors, process the input data, and trigger the actuators in response to the processed input data, based on instruction or code programmed therein, corresponding to one or more routines. An example control routine is described herein with reference to FIG. 6.

It will be appreciated that vehicle system 6 is shown by way of example, and as such is not meant to be limiting. Therefore, vehicle system 6 may include additional and/or alternative components than those illustrated in FIG. 1. For example, vehicle system 6 may include an exhaust gas recirculation (EGR) loop. Further, it will be appreciated that engine 10 may be any suitable engine, and is not limited to the cylinder block configuration depicted in FIG. 1. For example, engine 10 may include more or less cylinders in any suitable arrangement (e.g., V-configuration, horizontally opposed configuration, in-line configuration, etc.) without departing from the scope of this disclosure.

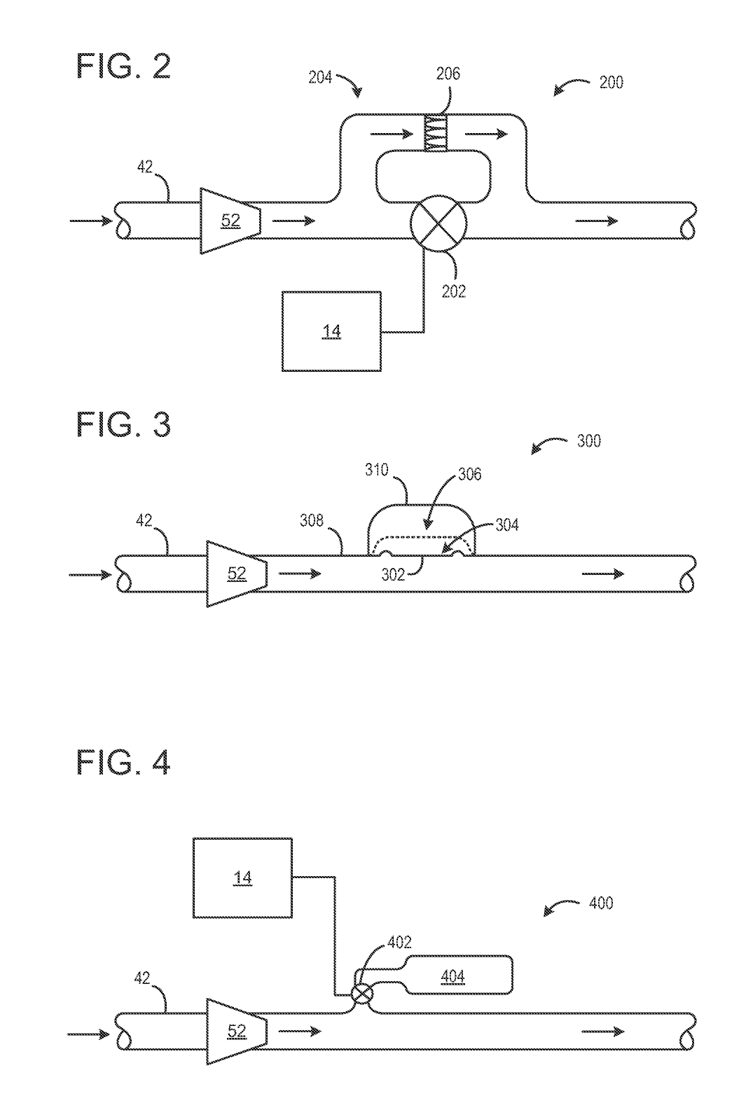

FIGS. 2-5 may include various features already described with respect to FIG. 1. For the sake of brevity, description of such features will not be repeated. It will be appreciated that like components are referenced with common numbers for FIGS. 1-5.

It will be appreciated that the embodiments described with respect to FIGS. 2-5, in general, temporarily increase a volume of an engine air passage in communication with a turbocharger, wherein the turbocharger includes a compressor and a turbine. Temporarily increasing the volume of the engine air passage may be achieved by selectively communicating a pulsation absorption device with the air passage at a position between the compressor and the turbine.

FIG. 2 shows an example pulsation absorption system 200 that may be included in the example engine of FIG. 1. As shown, pulsation absorption system 200 may be integrated with intake passage 42 and located downstream from compressor 52. Further, pulsation absorption system 200 may be located substantially close to an outlet of the compressor, as shown. Pulsation absorption system 200 may selectively communicate with the engine intake air flow via bypass valve 202. In this way, a volume of intake passage 42 may be temporarily increased by selectively communicating pulsation absorption system 200 with intake passage 42.

Further, control system 14 may be coupled to bypass valve 202 to open/close the valve, and thus, selectively communicate pulsation absorption system 200 with intake passage 42. For example, the control system may at least partially close bypass valve 202 at low engine speeds. Further, the control system may close bypass valve 202 at low engine speeds after a threshold boost level is achieved. In this way, air may be diverted to pulsation absorption system 200 to reduce pressure fluctuations which may affect turbocharger performance. Said in another way, a volume of the engine intake system may be increased when pulsation absorption system 200 is enabled to communicate with the engine intake system.

As another example, the control system may open bypass valve 202 at high engine speeds. In this way, a pressure drop across the pulsation adsorption system 200 is minimized at high flow rates. Further, an open bypass valve at high engine speeds may allow for a steady intake airflow to pass through the engine intake system uninhibited by pulsation absorption system 200. In other words, the volume of the engine intake system may be unchanged during high engine speeds, for example.

As shown, pulsation absorption system 200 may include a bypass passage 204 with one-way valve 206 positioned therein.

Bypass passage 204 may include a portion substantially parallel to intake passage 42. Further, bypass passage 204 may include a portion in fluidic communication with intake passage 42 upstream from bypass valve 202 and a portion in fluidic communication with intake passage 42 downstream from bypass valve 202. In this way, under some operating conditions, air flow may be diverted from intake passage 42 and through bypass passage 204 to re-enter intake passage 42 downstream from bypass valve 202. For example, when bypass valve 202 is closed, air flow may be diverted through bypass passage 204, and thus, through one-way valve 206. In this way, the volume of the intake passage 42 may be temporarily increased by at least partially closing bypass valve 202 such that bypass passage 204 communicates with intake passage 42, increasing the volume of the air passage through which the engine airflow flows. Thus, compressor surge may be reduced.

One-way valve 206 may enable unidirectional airflow through bypass passage 204. For example, one-way valve 206 may be a check valve such as a reed valve. Thus, one-way valve 206 may be comprised of a flexible metal or a flexible composite metal to restrict airflow to a single direction by opening and closing in response to changing pressure. In this way, one-way valve 206 prevents backflow. Further, one-way valve 206 may reduce pressure and flow fluctuations; and therefore, may contribute to reducing compressor surge conditions.

It will be appreciated that pulsation absorption system 200 is provided by way of example and may include additional and/or alternative features than those shown in FIG. 2. Further, pulsation absorption system 200 may form any suitable geometric configuration without departing from the scope of this disclosure. Further still, it will be appreciated that pulsation absorption system 200 may be located in another position that the embodiment illustrated in FIG. 1 without departing from the scope of this disclosure. For example, the pulsation absorption system 200 may selectively communicate with the engine intake system upstream from one or more intake ports. As such, the bypass passage and the one-way valve may be arranged substantially in parallel with one or more intake runners. Further, in such a scenario, the one or more intake runners may include a bypass valve positioned therein.

As another example, the pulsation absorption system may be configured to absorb pressure fluctuations independently from a control system. In this way, pulsation absorption system may not selectively communicate with the engine intake system. As such, the pulsation absorption system may be configured to passively absorb pressure surges while reducing turbo lag.

For example, FIG. 3 shows an example pulsation absorption system 300 that may be included in the example engine of FIG. 1. As shown, pulsation absorption system 300 may be integrated with intake passage 42 and located downstream from compressor 52. Further, pulsation absorption system 300 may be located substantially close to an outlet of the compressor, as shown. Pulsation absorption system 300 may be configured to compensate for pressure fluctuations by reducing the amplitude of such fluctuations without communicating with a control system. In this way, pulsation absorption system 300 may temporarily increase the volume of the engine intake system.

Pulsation absorption system 300 may include a diaphragm 302 to absorb pressure fluctuations without permanently increasing dead volume of the intake system, and further, without including a valve. In this way, diaphragm 302 may passively absorb pressure surges. Therefore, diaphragm 302 may be a flexible component that may deform in response to a pressure surge. For example, diaphragm 302 may be an elastomeric membrane or a plastomeric membrane that expands in response to a pressure surge and returns to a resting/relaxed state in the absence of the pressure surge. As such, diaphragm 302 may have a relaxed state (indicated generally at 304) and an expanded state (indicated generally at 306). As shown, the relaxed state may closely align with a wall 308 of intake passage 42. As one example, diaphragm 302 in the relaxed state may be substantially flush with wall 308 of intake passage 42. Further, the expanded state may extend away from wall 308 such that diaphragm 302 moves in a direction away from an interior of intake passage 42. In other words, the expanded state may include diaphragm 302 expanding towards an exterior of intake passage 42. In this way, diaphragm 302 may expand to increase the volume of intake passage 42 at the location of diaphragm 302. In other words, the cross sectional area of intake passage 42 may increase within a region coinciding with diaphragm 302, when diaphragm 302 expands to absorb a pressure surge.

Since diaphragm 302 may dynamically adjust to pressure surges, it will be appreciated that diaphragm 302 may temporarily expand to absorb a pressure surge. Thus, a volume of intake passage 42 may temporarily increase at a position of the engine air passage coinciding with diaphragm 302. Further, by virtue of the term temporarily increasing, diaphragm 302 may return to the relaxed state such that the volume of intake passage 42 at the position coinciding with diaphragm 302 may return to a normal operating volume. For example, the normal operating volume may indicate a volume of the engine air passage during engine operating conditions other than compressor surge conditions.

Further, it will be understood that diaphragm 302 may be a permeable membrane, a semi-permeable membrane, or a non-permeable membrane. Therefore, airflow may be permitted to pass through diaphragm (unidirectional, or bidirectional), or airflow may be contained within intake passage 42 without passing through diaphragm. In other words, diaphragm 302 may enable airflow to return to a main flow of the intake passage. Further, it will be appreciated that diaphragm 302 may be comprised of any suitable material, and is not limited to the elastomeric and plastomeric examples, provided above.

Pulsation absorption system 300 may further include a housing 310 surrounding diaphragm 302. Housing 310 may provide a protective enclosure for diaphragm 302. Therefore, housing 310 may extend from an exterior surface of intake passage 42 to enclose diaphragm 302. Housing 310 may be positioned beyond an expanded state of diaphragm 302 such that diaphragm 302 has sufficient room in which to expand without contacting an inner surface of housing 310. Further, housing 310 may be a reservoir for airflow and/or particles suspended within or carried by the airflow that may pass through diaphragm 302. For example, diaphragm 302 may be a permeable or semi-permeable membrane, and as such, airflow and/or particles suspended within the airflow may pass through diaphragm 302 and may be contained within housing 310. Therefore, housing 310 may provide dual functionality: a protective enclosure for diaphragm 302, and a trap for airflow particles. In some embodiments, housing 310 may include a filter to trap airflow particles.

It will be appreciated that pulsation absorption system 300 is provided by way of example, and thus, is not meant to be limiting. As such, pulsation absorption system 300 may include additional and/or alternative components than those illustrated in FIG. 3. For example, an expandable bladder may be used in lieu of a diaphragm to dampen pressure and flow fluctuations without permanently increasing the dead volume of the intake system, and further, without including a valve. As another example, the pulsation absorption system may include a spring-loaded accumulator, which may be configured to resonate at a desired frequency. Similar to the other examples, the spring-loaded accumulator may absorb pressure and flow fluctuations without increasing the dead volume of the intake system, and further, without including a valve.

Further, pulsation absorption system 300 may form any suitable geometric configuration without departing from the scope of this disclosure. For example, diaphragm 302, and likewise housing 310, may circumferentially surround intake passage 42. In this way, diaphragm 302 may expand to absorb a pressure surge such that the diaphragm expands circumferentially in a direction away from an interior of intake passage 42. As such, the cross sectional area of the intake passage may increase within a region coinciding with the circumferential diaphragm, when the diaphragm is in the expanded state. In other words, the diameter of the intake passage may increase when the circumferential diaphragm is in the expanded state.

FIG. 4 shows another example pulsation absorption system 400 that may be included in the example engine of FIG. 1. As shown, pulsation absorption system 400 may be integrated with intake passage 42 and located downstream from compressor 52. Further, pulsation absorption system 300 may be located substantially close to an outlet of the compressor, as shown. Pulsation absorption system 400 may be configured to absorb pressure surges by reducing the amplitude of such surges. Pulsation absorption system 400 may include a bypass valve 402 that enables pulsation absorption system 400 to selectively communicate with the engine intake air flow. In this way, pulsation absorption system may selectively communicate with intake passage 42 to temporarily increase the volume of the intake system to absorb pressure and flow fluctuations. As such, compressor surge conditions may be reduced.

Further, control system 14 may be coupled to valve 402 to open/close the valve, and thus, selectively communicate pulsation absorption system 400 with intake passage 42. For example, the control system may open valve 402 at low engine speeds. Further, the control system may open valve 402 at low engine speeds after a threshold boost level is achieved. Such operating conditions may coincide with pressure fluctuations in the engine intake system. Therefore, by enabling pulsation absorption system 400 to communicate with intake passage 42, pressure surges may be absorbed by pulsation absorption system 400. As another example, the control system may close valve 402 at high engine speeds. As such, pulsation absorption system 400 may not communicate with intake passage 42. For example, such operating conditions may provide a steady flow of intake air, and thus, may not be subject to pressure surges. Therefore, it may be undesirable for pulsation absorption system 400 to communicate with intake passage 42 in such conditions.

As introduced above, pulsation absorption system may include valve 402 that enables the pulsation absorption system to selectively communicate with the engine intake air flow. Valve 402 may be any suitable valve for selectively communicating resonator 404 with the engine intake air system. For example, valve 402 may be a butterfly valve, a check valve, or another valve. Therefore, valve 402 may configured for bidirectional airflow or unidirectional airflow without departing from the scope of this disclosure. A bidirectional airflow valve may allow backflow from pulsation absorption system 400 to intake passage 42. For example, air may leak past valve 402 and re-enter intake passage 42 in some conditions. However, it will be appreciated that if valve 402 enables unidirectional airflow, that pulsation absorption system 400 may include a vent, bleed valve, etc. downstream from valve 402 to release air pressure when the absorbed airflow exceeds a threshold, for example.

Pulsation absorption system may further include a resonator 404 downstream from valve 402. Resonator 404 may be a dead-end side branch of the engine intake system, for example. As such, resonator 404 may be a reservoir for pressure pulsations. In this way, resonator 404 may provide a volumetric space to house intake air that surges beyond a threshold value. For example, if valve 402 is open, resonator 404 may absorb a pressure surge by housing intake air flow that passes through valve 402. Since valve 402 selectively communicates resonator 404 with intake passage 24, opening valve 402 temporarily increases a volume of intake passage 24 until valve 402 closes. In this way, the volume may be increased to absorb a pressure surge, and thus, compressor surge conditions may be reduced.

Resonator 404 may have dimensions configured to resonate at a particular frequency that is suitable for absorbing pressure surges within intake passage 42.

It will be appreciated that pulsation absorption system 400 is provided by way of example, and thus, is not meant to be limiting. Further, pulsation absorption system 400 may form any suitable geometric configuration without departing from the scope of this disclosure. Further still, pulsation absorption system 400 may include additional and/or alternative components than those illustrated in FIG. 4. For example, pulsation absorption system 400 may be located in another position. As one non-limiting example, the pulsation absorption system may be coupled to the engine exhaust system.

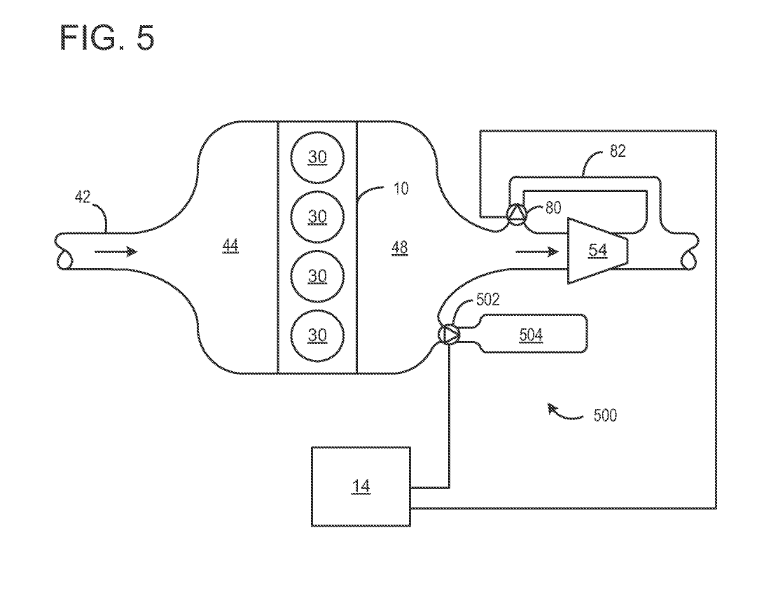

For example, FIG. 5 shows example pulsation absorption system 500 that may be coupled to engine exhaust system 25 of FIG. 1. As shown, pulsation absorption system 500 may be coupled to exhaust manifold 48. Further, pulsation absorption system 500 may be located upstream from turbine 54. For example, pulsation absorption system 500 may be located in close proximity to an inlet of turbine 54. Pulsation absorption system 500 may be configured to selectively communicate with exhaust manifold 48 to absorb pressure surges. In this way, pulsation absorption system 500 may temporarily increase the volume of the exhaust manifold to absorb pressure and flow fluctuations. As such, compressor surge conditions may be reduced.

Some components of pulsation absorption system 500 may similar to pulsation absorption system 400. For example, pulsation absorption system 400 may include a resonator 504 similar to resonator 404. However, it will be appreciated that resonator 504 may comprise different dimensions and/or different materials than resonator 404. For example, resonator 504 may have dimensions configured to resonate at a particular frequency that is suitable for absorbing pressure surges within exhaust manifold 48.

Pulsation absorption system 500 may further include a valve 502 to selectively communicate with exhaust manifold 48. For example, valve 502 may be a flapper valve such as a wastegate valve. Thus, valve 502 may be similar to wastegate valve 80, for example.

Further, control system 14 may be coupled to valve 502 to open/close the valve, and thus, selectively communicate pulsation absorption system 500 with exhaust manifold 48. For example, the control system may open valve 502 at low engine speeds. Further, the control system may open valve 502 at low engine speeds after a threshold boost level is achieved. Such operating conditions may coincide with pressure fluctuations in the engine intake system. Therefore, by enabling pulsation absorption system 500 to communicate with exhaust manifold 48, pressure surges may be absorbed by pulsation absorption system 500. As another example, the control system may close valve 502 at high engine speeds. As such, pulsation absorption system 500 may not communicate with exhaust manifold 48. For example, such operating conditions may provide a steady flow of exhaust air, and thus, may not be subject to pressure surges. Therefore, it may be undesirable for pulsation absorption system 500 to communicate with exhaust manifold 48 in such conditions.

Since valve 502 selectively communicates resonator 504 with exhaust manifold 48, opening valve 502 temporarily increases a volume of exhaust manifold 48 until valve 502 closes. In this way, the volume may be increased to absorb a pressure surge, and thus, compressor surge conditions may be reduced.

It will be appreciated that pulsation absorption system 500 is provided by way of example, and thus, is not meant to be limiting. Further, pulsation absorption system 500 may form any suitable geometric configuration without departing from the scope of this disclosure. Further still, pulsation absorption system 500 may include additional and/or alternative components than those illustrated in FIG. 5. For example, pulsation absorption system 500 may be located in another position. As one non-limiting example, the pulsation absorption system may be coupled to an intake manifold.

FIG. 6 shows a flowchart for a controller of the example engine of FIG. 1 for controlling a pulsation absorption system, such as pulsation absorption systems 200, 400, and 500.

At 602, method 600 includes receiving an engine operating condition from a sensor. For example, the engine operating condition may indicate an engine speed, an engine load, etc.

At 604, method 600 includes determining if a compressor surge condition occurs. For example, the compressor surge condition may include an engine operating condition with a low engine speed below a threshold, but not a high engine speed above the threshold. Further, the engine operating condition may include at least some engine boost. As such, the compressor surge condition may indicate a high probability for pressure and/or flow fluctuations in the engine intake and/or engine exhaust flows. Such engine operating conditions may indicate compressor surge, for example. It will be appreciated that the compressor surge condition may include actual surge, such as determining the compressor surge condition in real-time, as the compressor surge is actually happening. Further, it will be appreciated that the compressor surge condition may include potential surge, such that the engine operating condition may be used to predict or anticipate a potential compressor surge condition. If the answer to 604 is NO, method 600 proceeds to 606. If the answer to 604 is YES, method 600 proceeds to 608.

At 606, method 600 includes not actuating a pulsation absorption system. Therefore, the volume of an engine air passage in which the pulsation absorption system is coupled to may not be increased.

At 608, method 600 includes actuating the pulsation absorption system. For example, actuating the pulsation absorption system may include communicating a pulsation absorption device with the engine intake system and/or the engine exhaust system. Therefore, the pulsation adsorption device may increase the volume of the intake and/or exhaust systems to absorb pressure and/or flow fluctuations. As described above, the pulsation absorption system selectively communicates with the engine airflow, and as such, the volume of the intake and/or exhaust system may only be temporarily increased when absorbing pressure and/or flow fluctuations is desired. In this way, the tendency for compressor surge can be reduced by determining the compressor surge condition in real-time based on engine operating conditions and/or by predicting the compressor surge condition based on engine operating conditions.

It will be appreciated that method 600 is provided by way of example, and thus, is not meant to be limiting. As such, method 600 may include additional and/or alternative steps than those shown in FIG. 6. Further, it will be appreciated that the steps illustrated may be performed in any suitable order. Further still, it will be appreciated that in some embodiments, one or more steps may be eliminated, if appropriate.

It will be appreciated that the pulsation absorption systems and method examples provided herein are non-limiting. It is within the scope of this disclosure that the pulsation absorption system may include a pulsation absorption device that is configured to selectively and/or temporarily communicate with an airflow of an engine. As such, the pulsation absorption device (e.g., a resonator, a diaphragm, a bladder, a bypass passage, etc.) may be coupled to any component of the intake and/or exhaust systems to reduce the tendency for compressor surge. For example, the pulsation absorption device may be coupled to the intake passage, the intake manifold, one or more intake runners, the exhaust manifold, and/or an exhaust passage. However, it will be appreciated that one or more of the pulsations absorption devices may be positioned downstream from a compressor and/or upstream from a turbine.

Further, in some embodiments, a pulsation absorption system may include an actuator similar to an active noise cancellation device. Such a device may be used in addition or alternative to the embodiments described herein.

It will be appreciated that the configurations and routines disclosed herein are exemplary in nature, and that these specific embodiments are not to be considered in a limiting sense, because numerous variations are possible. For example, the above technology can be applied to V-6, I-4, I-6, V-12, opposed 4, and other engine types. The subject matter of the present disclosure includes all novel and non-obvious combinations and sub-combinations of the various systems and configurations, and other features, functions, and/or properties disclosed herein.

The following claims particularly point out certain combinations and sub-combinations regarded as novel and non-obvious. These claims may refer to “an” element or “a first” element or the equivalent thereof. Such claims should be understood to include incorporation of one or more such elements, neither requiring nor excluding two or more such elements. Other combinations and sub-combinations of the disclosed features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure.

1. An engine comprising:
a turbocharger in fluidic communication with an air passage, the turbocharger including a compressor and a turbine; and
a pulsation absorption device coupled to the air passage at a position between the compressor and the turbine, the pulsation absorption device temporarily increasing a volume of the air passage.

2. The engine of claim 1, wherein the pulsation absorption device is coupled to the air passage downstream from the compressor in close proximity to an outlet of the compressor.

3. The engine of claim 2, further comprising a bypass valve positioned within the air passage downstream from the compressor, wherein the pulsation absorption device includes a bypass passage with a valve positioned therein, the bypass passage diverting an airflow from a region upstream from the bypass valve to a region downstream of the bypass valve.

4. The engine of claim 3, wherein the valve is a reed valve positioned within a portion of bypass passage that is substantially parallel to the air passage.

5. The engine of claim 3, wherein the bypass valve is coupled to a control system, the control system closing the bypass valve during low engine speeds to reduce a pulsation.

6. The engine of claim 5, wherein the control system opens the bypass valve during high engine speeds.

7. The engine of claim 2, wherein the pulsation absorption device is a diaphragm that aligns with a wall of the air passage.

8. The engine of claim 7, wherein the diaphragm absorbs a pulsation by expanding beyond the wall of the air passage, the diaphragm returning to a relaxed state in an absence of the pulsation.

9. The engine of claim 7, further comprising a housing to enclose the diaphragm from outside the air passage.

10. The engine of claim 2, wherein the pulsation absorption device is a resonator that stores a pulsation when a valve positioned between the resonator and the air passage is open.

11. The engine of claim 10, wherein a controller actuates the valve to open at low engine speeds.

12. The engine of claim 1, wherein the pulsation absorption device is coupled to the air passage upstream from the turbine in close proximity to an inlet of the turbine.

13. The engine of claim 12, wherein the pulsation absorption device is a resonator coupled to an exhaust manifold, the pulsation absorption device storing a pulsation when a valve positioned between the resonator and the exhaust manifold is open.

14. The engine of claim 13, wherein a controller actuates the valve to open at low engine speeds.

15. The engine of claim 1, wherein the compressor is in fluidic communication with an intake passage and the turbine is in fluidic communication with an exhaust passage, the pulsation absorption device coupled to the air passage downstream from the compressor and upstream from the turbine.

16. A pulsation absorption system comprising:
a turbocharger including a compressor and a turbine in fluidic communication with an air passage of an engine;
a pulsation absorption device coupled to the air passage between the compressor and the turbine;
a valve positioned between the air passage and the pulsation absorption device; and
an actuator that actuates the valve to selectively communicate the pulsation absorption device with the air passage.

17. The system of claim 16, wherein the pulsation absorption device is a resonator.

18. The system of claim 16, wherein the actuator actuates the valve to enable communication between the air passage and the pulsation absorption device when the engine is operating at a low engine speed.

19. A method for an engine comprising:
actuating a pulsation absorption system to increase a volume of an engine air passage in response to a compressor surge condition during engine operation.

20. The method of claim 19, wherein the compressor surge condition includes an engine operating condition with a low engine speed below a threshold, but not a high engine speed above the threshold.

21. The method of claim 19, wherein the compressor surge condition includes actual surge, and wherein actuating the pulsation absorption system includes increasing the volume of the engine air passage in real-time in response to actual surge.

22. The method of claim 19, wherein the compressor surge condition includes potential surge, and wherein actuating the pulsation absorption system includes increasing the volume of the engine air passage to anticipate potential surge.
